(19) United States
(12) Patent Application Publication
(10) Pub. No.: US 2015/0260352 A1
(43) Pub. Date: Sep. 17, 2015

(54) LED BULB WITH CHASSIS FOR PASSIVE CONVECTIVE LIQUID COOLING

(71) Applicant: Switch Bulb Company, Inc., San Jose, CA (US)

(72) Inventors: Matrika BHATTARAI, San Jose, CA (US); Kevin CIOCIA, San Francisco, CA (US); Elijah KIM, San Jose, CA (US); Andrew HEISEY, Walnut Creek, CA (US); Myron MORENO, San Jose, CA (US); Ronan LE TOQUIN, Sunnyvale, CA (US); Prahallad IYENGAR, Sunnyvale, CA (US); David HORN, Saratoga, CA (US)

(73) Assignee: Switch Bulb Company, Inc., San Jose, CA (US)

(21) Appl. No.: 14/214,451

(22) Filed: Mar. 14, 2014

(51) Int. Cl. F21K 99/00; F21V 29/56

(52) U.S. Cl. CPC F21K 9/1355; F21V 29/56; F21Y 2101/02

(57) ABSTRACT

A light emitting diode (LED) bulb includes a base, a shell connected to the base forming an enclosed volume, a chassis disposed within the shell, and a plurality of LEDs disposed with the shell. The LED bulb also includes a thermally conductive liquid disposed within the enclosed volume. The LEDs and the chassis are immersed in the thermally conductive liquid. The chassis has a first opening and a second opening. The second opening is spaced from the first opening to facilitate a passive convective flow of the thermally conductive liquid to exchange a first volume of the thermally conductive liquid interior the chassis with a second volume of the thermally conductive liquid exterior the chassis.

### BACKGROUND

1. Field

The present disclosure relates generally to liquid-filled light emitting diode (LED) bulbs, and more specifically to an LED bulb with a chassis configured to provide passive convective liquid cooling of LEDs.

2. Description of Related Art

Traditionally, lighting has been generated using fluorescent and incandescent light bulbs. While both types of light bulbs have been reliably used, each suffers from certain drawbacks. For instance, incandescent bulbs tend to be inefficient, using only 2-3% of their power to produce light, while the remaining 97-98% of their power is lost as heat. Fluorescent bulbs, while more efficient than incandescent bulbs, do not produce the same warm light as that generated by incandescent bulbs. Additionally, there are health and environmental concerns regarding the mercury contained in fluorescent bulbs.

Thus, an alternative light source is desired. One such alternative is a bulb utilizing an LED. An LED comprises a semiconductor junction that emits light due to an electrical current flowing through the junction. Compared to a traditional incandescent bulb, an LED bulb is capable of producing more light using the same amount of power. Additionally, the operational life of an LED bulb is orders of magnitude longer than that of an incandescent bulb, for example, 10,000-100,000 hours as opposed to 1,000-2,000 hours.

While there are many advantages to using an LED bulb rather than an incandescent or fluorescent bulb, LEDs have a number of drawbacks that have prevented them from being as widely adopted as incandescent and fluorescent replacements. One drawback is that an LED, being a semiconductor, generally cannot be allowed to get hotter than approximately 120° C. As an example, A-type LED bulbs have been limited to very low power (i.e., less than approximately 8 W), producing insufficient illumination for incandescent or fluorescent replacements.

One potential solution to this problem is to use a large metallic heat sink attached to the LEDs and extending away from the bulb. However, this solution is undesirable because of the common perception that customers will not use a bulb that is shaped radically different from the traditionally shaped A-type form factor bulb. Additionally, the heat sink may make it difficult for the LED bulb to fit into preexisting fixtures.

### BRIEF SUMMARY

In one exemplary embodiment, a light emitting diode (LED) bulb includes a base, a shell connected to the base forming an enclosed volume, a chassis disposed within the shell, and a plurality of LEDs disposed with the shell. The LED bulb also includes a thermally conductive liquid disposed within the enclosed volume. The LEDs and the chassis are immersed in the thermally conductive liquid. The chassis has a first opening and a second opening. The second opening is spaced from the first opening to facilitate a passive convective flow of the thermally conductive liquid to exchange a first volume of the thermally conductive liquid interior the chassis with a second volume of the thermally conductive liquid exterior the chassis.

### DESCRIPTION OF THE FIGURES

The patent or application file contains at least one drawing executed in color. Copies of this patent or patent application publication with color drawing(s) will be provided by the Office upon request and payment of the necessary fee.

FIG. 1A depicts an exemplary LED bulb.

FIG. 1B depicts a cross-sectional view of the exemplary LED bulb.

FIG. 2 depicts an exemplary support structure of the exemplary LED bulb.

FIG. 3 depicts an exemplary chassis of the exemplary LED bulb.

FIGS. 4A-4C depict passive convective flow of thermally conductive liquid overlaid on a cross-sectional view of the exemplary LED bulb.

FIGS. 5A-5D depict cross-sectional views of thermal models of the heat distribution for various configurations of the exemplary LED bulb.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below, relating to LED bulbs. As used herein, an “LED bulb” refers to any light-generating device (e.g., a lamp) in which at least one LED is used to generate the light. Thus, as used herein, an “LED bulb” does not include a light-generating device in which a filament is used to generate the light, such as a conventional incandescent light bulb.

As used herein, the term “liquid” refers to a substance capable of flowing. Also, the substance used as the thermally conductive liquid is a liquid or at the liquid state within, at least, the operating ambient temperature range of the bulb. An exemplary temperature range includes temperatures between −40° C. to +40° C. Also, as used herein, “passive convective flow” refers to the circulation of a liquid without the aid of a fan or other mechanical devices driving the flow of the thermally conductive liquid.

### 1. Exemplary LED Bulb

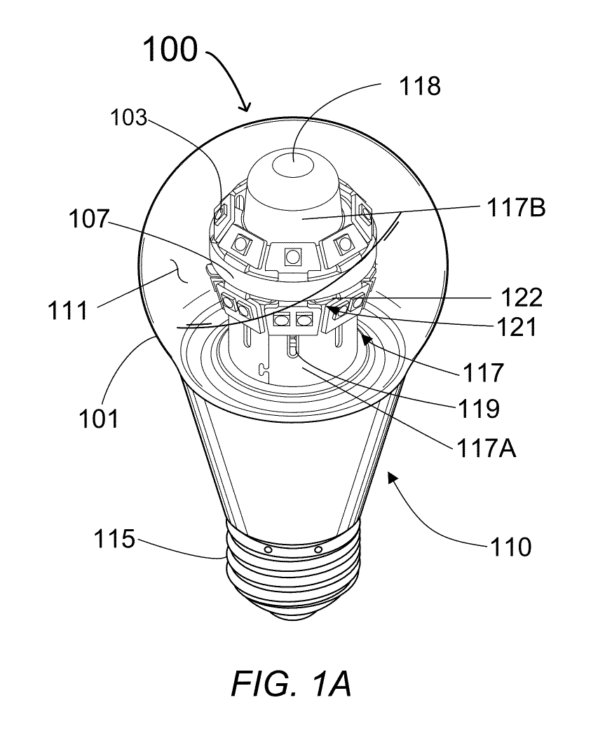

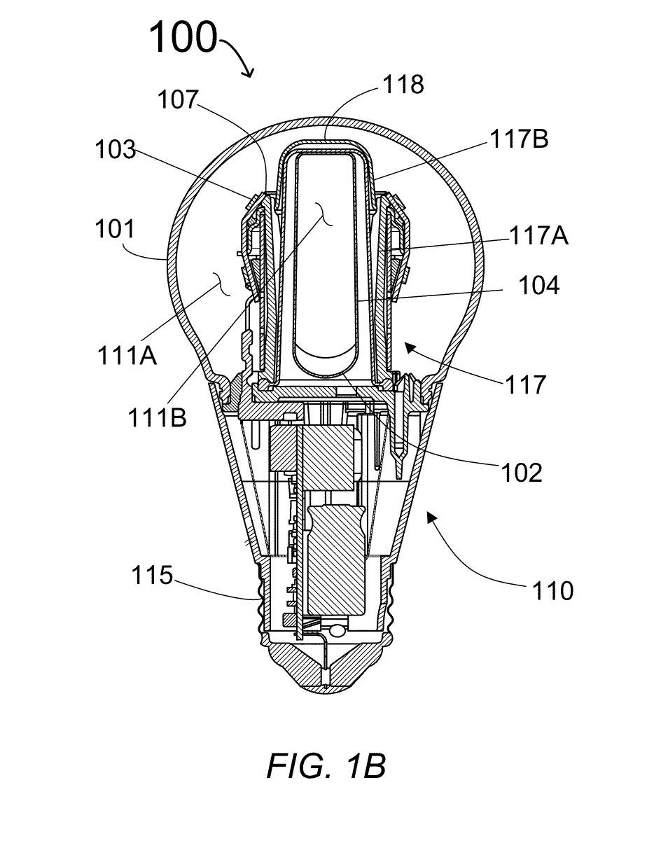

FIGS. 1A and 1B illustrate a perspective view and a cross-sectional view, respectively, of exemplary LED bulb 100. LED bulb 100 includes a shell 101 and a base 110 forming an enclosed volume. For convenience, all examples provided in the present disclosure describe and show LED bulb 100 being a standard A-type form factor bulb. It should be appreciated, however, that the present disclosure may be applied to LED bulbs having any shape, such as a tubular bulb, globe-shaped bulb, or the like.

Shell 101 may be made from any transparent or translucent material such as plastic, glass, polycarbonate, or the like. Shell 101 may include dispersion material spread throughout the shell to disperse light. The dispersion material prevents LED bulb 100 from appearing to have one or more point sources of light.

Base 110 of LED bulb 100 includes a connector base 115 for connecting the bulb to a lighting fixture. In the present embodiment, connector base 115 has threads for insertion into a conventional light socket in the U.S. It should be appreciated, however, that connector base 115 may be any type of connector, such as a screw-in base, a dual-prong connector, a standard two- or three-prong wall outlet plug, bayonet base, Edison Screw base, single pin base, multiple pin base, recessed base, flanged base, grooved base, side base, or the like.

A thermally conductive liquid 111 is disposed within the enclosed volume formed by shell 101 and base 110. Thermally conductive liquid 111 may be any thermally conductive liquid, mineral oil, silicone oil, glycols (PAGs), fluorocarbons, or other material capable of flowing. It may be desirable to have the liquid chosen be a non-corrosive dielectric. Selecting such a liquid can reduce the likelihood that the liquid will cause electrical shorts and reduce damage done to the components of LED bulb 100.

In the present exemplary embodiment, LED bulb 100 includes a liquid-volume compensator mechanism to facilitate thermal expansion of thermally conductive liquid 111 contained in the LED bulb 100. In the exemplary embodiment depicted in FIG. 1B, the liquid-volume compensation mechanism is a compressible bladder 104, which contains a compressible medium (e.g., a gas, foam, compressible gel, or the like). The volume compensation mechanism, however, can be a diaphragm, such as a flexible membrane made of an elastomer or synthetic rubber, such as Viton, silicone, fluorosilicone, fluorocarbon, Nitrile rubber, or the like. The liquid-volume compensator mechanism can also be formed from a disk, piston, vane, plunger, slide, closed cell foam, bellow, or the like.

LED bulb 100 includes LEDs 103 disposed within shell 101 and immersed in thermally conductive liquid 111. LED bulb 100 also includes a chassis 117, which is also disposed within shell 101 and immersed in thermally conductive liquid 111. Chassis 117 may be formed from a thermally conductive material, such as aluminum, copper, brass, magnesium, zinc, or the like. As will be described in more detail below, chassis 117 has a first opening 118 and a second opening 119, which is spaced from first opening 118, to facilitate a passive convective flow of thermally conductive liquid 111 to transfer heat generated by LEDs 103 to shell 101.

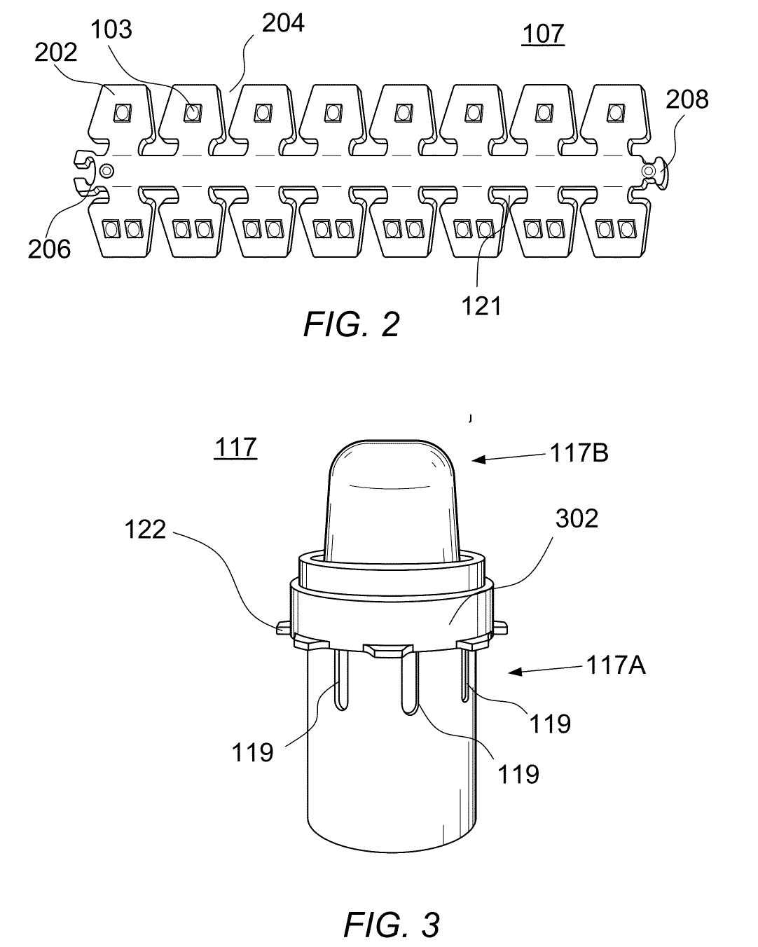

With reference to FIG. 2, in the present embodiment, LEDs 103 are mounted to support structure 107. In particular, LEDs 103 are mechanically, electrically, and thermally coupled to mounts 202 of support structure 107. In the present embodiment, mounts 202 are fingerlike projections with a channel 204 formed between pairs of mounts 202. Mounts 202 and channels 204 are configured to facilitate a passive convective flow of thermally conductive liquid through channels 204, when LED bulb 100 (FIG. 1A) is oriented in at least three different orientations. With reference to FIG. 1A, in a first orientation, shell 101 is disposed vertically above base 110. In a second orientation, shell 101 is disposed on the same horizontal plane as base 110. In a third orientation, shell 101 is disposed vertically below base 110. It should be recognized that mounts 202 can also be described as being posts, tabs, and the like.

Support structure 107 is preferably formed from a composite laminate material. Support structure 107 may comprise a thermally conductive material (e.g., aluminum, copper, brass, magnesium, zinc, or the like) to act as a heat sink and conduct heat energy away from LEDs 103. In the present embodiment, each LED 103 mounted on support structure 107 may be angled such that the plurality of LEDs 103 emits light that projects radially outward from the center of shell 101 to emulate the isotropic emission of point light source. It should be recognized, however, that LEDs 103 need not be angled. Also, LEDs 103 can be mounted directly to chassis 117 rather than to support structure 107.

As depicted in FIG. 1A, in the present embodiment, support structure 107 is formed in a toroidal configuration around chassis 117. Support structure 107 is secured around chassis 117 by engaging corresponding interlocking members disposed on opposite ends of support structure 107. As shown in FIG. 2, in the present embodiment, male interlocking member 208 and female interlocking member 206 are disposed on opposite ends of support structure 107. Male interlocking member 208 may be frictionally fitted into female interlocking member 206 to secure support structure 107 around chassis 117 in a toroidal configuration. It should be recognized that interlocking members 206 and 208 shown in FIG. 2 are exemplary and that other configurations may be used to engage together the opposite ends of support structure 107.

With reference to FIG. 1A, in the present embodiment, support structure 107 has openings 121 that engage with corresponding tabs 122 of chassis 117 to secure support structure 107 around chassis 117. Openings 121 of support structure 107 engage tabs 122 of chassis 117 to resist support structure 107 from slipping down or rotating with respect to chassis 117. One advantage of such a configuration is greater ease of assembly and lower production costs where, in the present embodiment, support structure 107 may be secured around chassis 117 without the use of fasteners or adhesives. It should be recognized, however, that instead of support structure 107 having openings that engage with corresponding tabs of chassis 117, support structure 107 may alternatively have tabs that engage with corresponding openings on chassis 117. Additionally, LED bulb 100 may include more than one support structure 107 and the support structures 107 may be attached in various configurations around chassis 117.

With reference to FIG. 3, in the present embodiment, chassis 117 comprises a body portion 117A and a cap portion 117B. In particular, body portion 117A interlocks with cap portion 117B. In the present embodiment, body portion 117A is tubular shaped, and cap portion 117B is dome shaped. Chassis 117 includes a center ridge portion 302. Center ridge portion 302 extends out from the outer surface of chassis 117. Tabs 122 are disposed on center ridge portion 302. As described above, referring back to FIG. 1A, support structure 107 is attached to chassis 117 at center ridge portion 302 (FIG. 3). It should be recognized, however, that chassis 117 may have various shapes.

As mentioned above and depicted in FIG. 1A, chassis 117 has first opening 118 and second opening 119, which is spaced from first opening 118, to facilitate a passive convective flow of thermally conductive liquid 111 to transfer heat generated by LEDs 103 to shell 101. In the present embodiment, first opening 118 is formed in cap portion 117B opposite base 110. First opening 118 is proximate a first end (depicted in FIG. 1A as being the top end) of the enclosed volume formed by shell 101 and base 110. Second opening 119 is proximate a second end (depicted in FIG. 1A as being the bottom end) of the enclosed volume formed by shell 101 and base 110. As depicted in FIG. 3, second opening 119 is formed as a set of slots spaced around the circumference of body portion 117A.

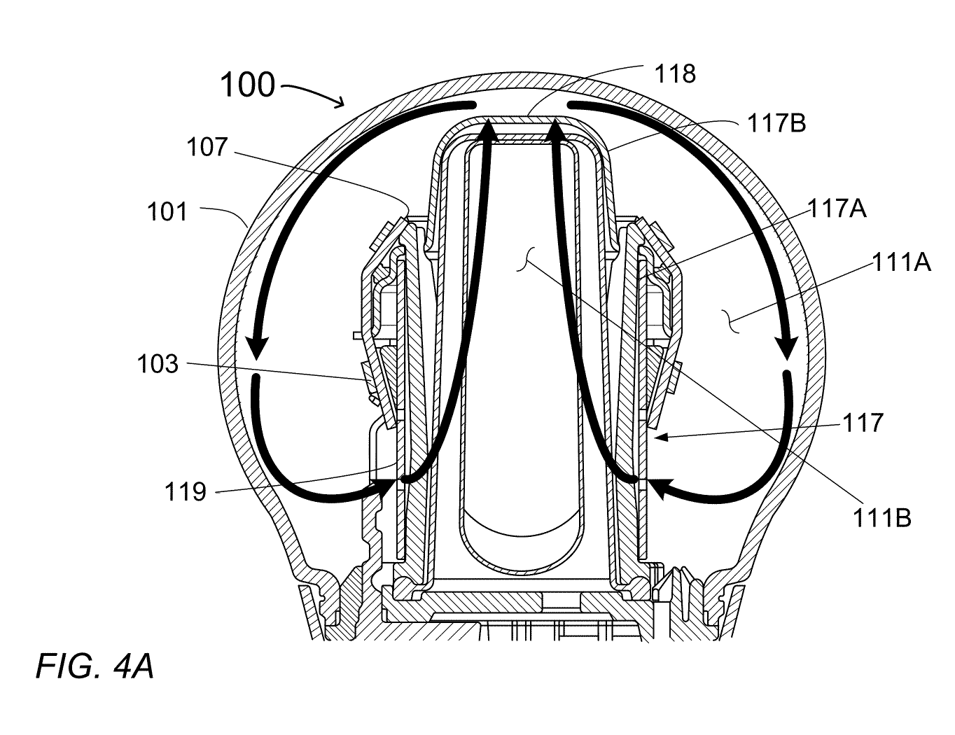

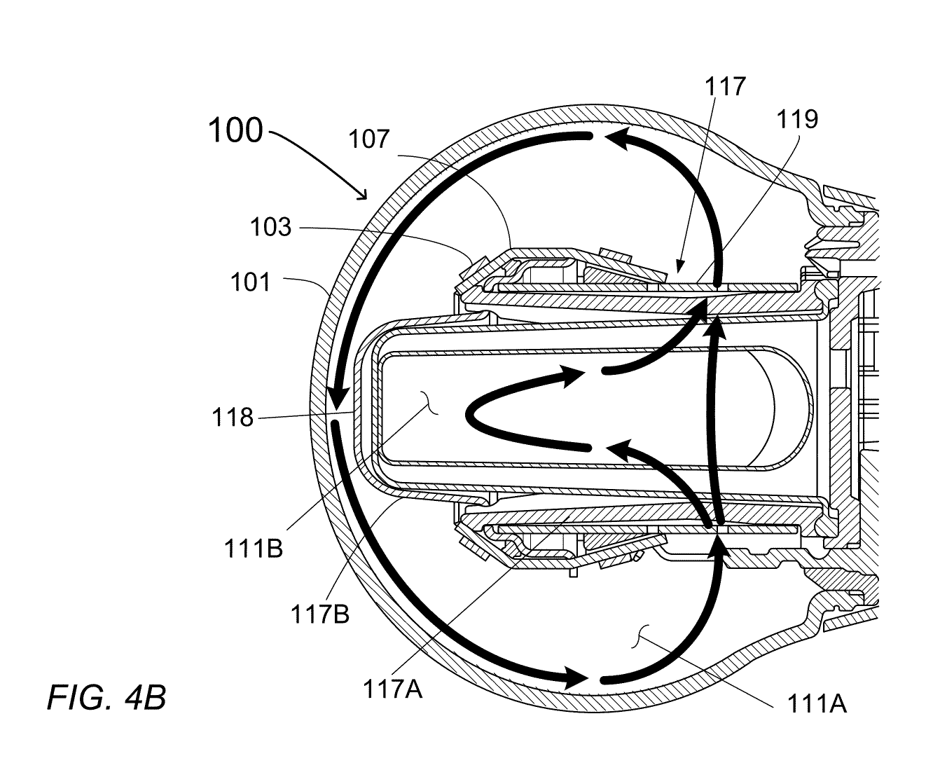

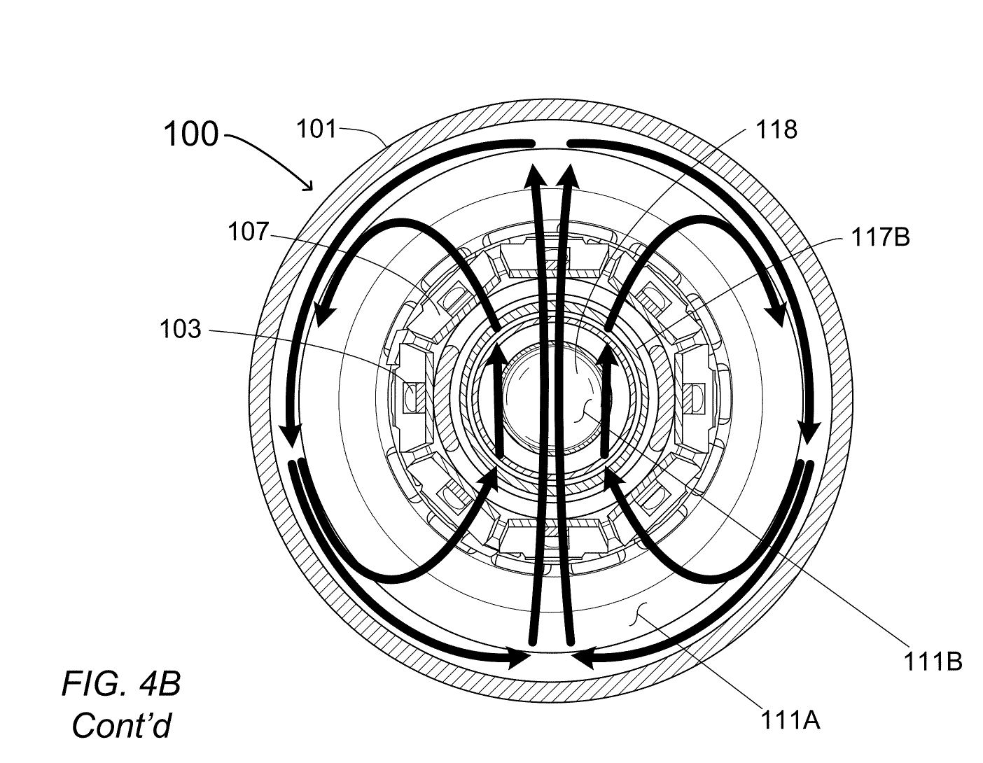

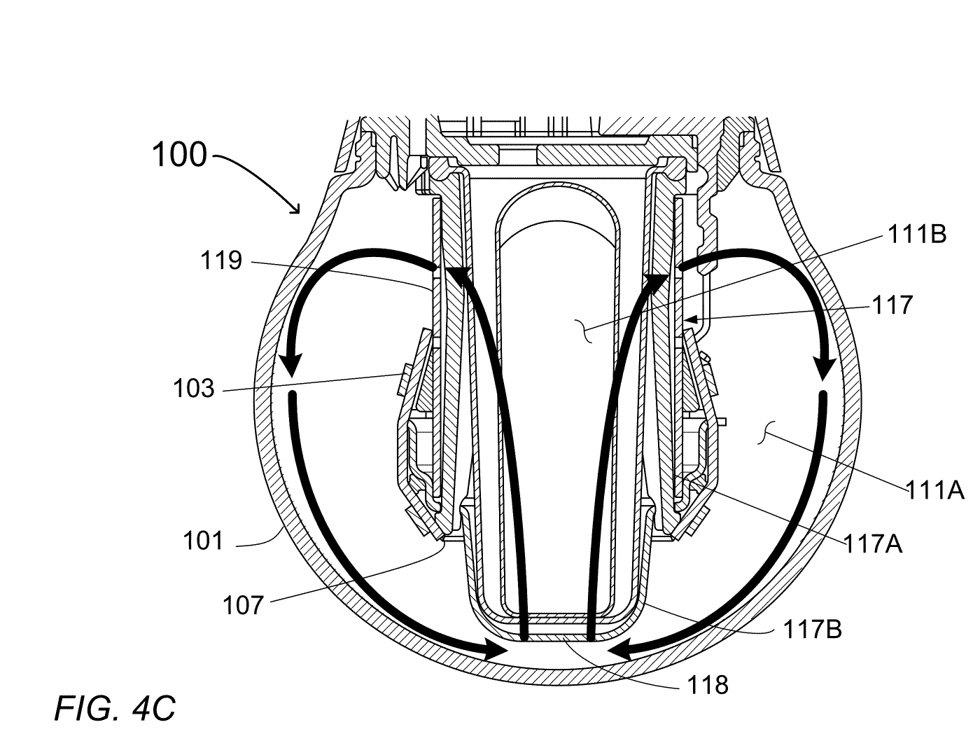

FIG. 1B depicts the interior of chassis 117 that encloses a volume of thermally conductive liquid. Heat generated by LEDs 103 is directed preferentially through chassis 117. As a result, the volume of thermally conductive liquid within the chassis 117 (volume 111B) near cap portion 117B heats up faster than the volume of thermally conductive liquid exterior chassis 117 (volume 111A). As will be described in greater detail below with respect to FIGS. 4A-4C, the thermal gradient between the inside and outside of chassis 117, combined with openings 118 and 119, facilitate the passive convective flow of liquid, which exchanges the cooler volume thermally conductive liquid exterior chassis 117 (volume 111A) with warmer volume of thermally conductive liquid within the chassis 117 (volume 111B).

FIGS. 4A-4C illustrate the passive convective flow of thermally conductive liquid overlaid on a cross-sectional view of LED bulb 100. In particular, FIG. 4A illustrates a cross-sectional view of the top portion of LED bulb 100 positioned in an upright vertical orientation in which shell 101 is disposed vertically above base 110 (FIG. 1A). The arrows indicate the direction of liquid flow during operation of LED bulb 100. The volume of thermally conductive liquid within the chassis 117 (volume 111B) at the center of LED bulb 100 is shown rising towards the top of shell 101. This is due to the heat generated by LEDs 103 and conductively transferred to the thermally conductive liquid via LEDs 103 to chassis 117. As the thermally conductive liquid is heated, its density decreases relative to the surrounding liquid, thereby causing the heated liquid to rise to the top of shell 101.

Chassis 117 separates the warmer volume of thermally conductive liquid within chassis 117 (volume 111B) from the cooler volume of thermally conductive liquid exterior the chassis 117 (volume 111A). This separation causes a thermal gradient that, when combined with openings 118 and 119, facilities the liquid to flow and intermix the cooler to the warmer regions of LED bulb 100. For example, since the volume of thermally conductive liquid within chassis 117 (volume 111B) heats faster than the surrounding liquid, an upward flow of thermally conductive liquid is generated within chassis 117. The warmer liquid rises through opening 118 passing from the interior to the exterior of chassis 117.

Once heated, the thermally conductive liquid reaches the top portion of shell 101. Heat is conductively transferred to shell 101, causing the volume of thermally conductive liquid exterior the chassis 117 (volume 111A) to cool. As the liquid cools, its density increases, thereby causing the liquid to fall. In one example, as illustrated by FIG. 4A, the volume of thermally conductive liquid within the chassis 117 (volume 111B) rises through opening 118 and forces a cooler volume of thermally conductive liquid exterior the chassis 117 (volume 111A) to flow down in close proximity to shell 101. By doing so, the liquid remains in contact with shell 101 for a greater period of time, allowing more heat to be conductively transferred to shell 101. In addition, since the downward flow of the liquid is concentrated along the surface of shell 101, the shear force between the upward flowing liquid at the center of LED bulb 100 and the downward flowing liquid along the surface of shell 101 is reduced, thereby increasing the convective flow of thermally conductive liquid within LED bulb 100.

Once reaching the bottom of shell 101, the volume of thermally conductive liquid exterior the chassis 117 (volume 111A) flows inwards through opening 119 and rises within chassis 117 as heat generated by LEDs 103 warms the liquid. The heated volume of thermally conductive liquid within chassis 117 (volume 111B) is again guided within the chassis 117 as described above. The described convective cycle continuously repeats during operation of LED bulb 100 to cool LEDs 103. It should be appreciated that the convective flow described above represents the general flow of liquid within shell 101. One of ordinary skill in the art will recognize that some of the thermally conductive liquid may not reach the top and bottom of shell 101 before being cooled or heated sufficiently to cause the liquid to fall or rise. It should also be recognized that the convective flow created by chassis 117 can supplement the convective flow created by mounts 202 and channels 204 (FIG. 2).

FIG. 4B illustrates two cross-sectional views of the top portion of LED bulb 100 positioned in a horizontal orientation in which shell 101 is disposed on the same plane as base 110. FIG. 4B includes both a side view of LED bulb 100 and a front view looking into the top portion of LED bulb 100. Similar to those in FIG. 4A, the arrows indicate the direction of liquid flow during operation of LED bulb 100. In the side view of FIG. 4B, the volume of thermally conductive liquid within chassis 117 (volume 111B) heats faster than the surrounding liquid and rises through opening 119 to the top (previously side) of shell 101. This is due to the heat generated by LEDs 103 and conductively transferred to the thermally conductive liquid via LEDs 103. As the thermally conductive liquid is heated, its density decreases, thereby causing the heated liquid to rise to the top (previously side) of LED bulb 100.

Once the heated, thermally conductive liquid reaches the top (previously side) portion of shell 101, heat is conductively transferred to shell 101, causing the volume of thermally conductive liquid exterior the chassis 117 (volume 111A) to cool. As the volume of thermally conductive liquid exterior the chassis 117 (volume 111A) cools, its density increases, thereby causing the liquid to fall. In one example, as illustrated by FIG. 4B, the volume of thermally conductive liquid within chassis 117 (volume 111B) rises through opening 119, impinges on shell 101 and cools. The cooler volume of thermally conductive liquid exterior the chassis 117 (volume 111A) flows down in close proximity to shell 101. By doing so, liquid remains in contact with shell 101 for a greater period of time, allowing more heat to be conductively transferred to shell 101.

As illustrated by the front view of FIG. 4B, the top-view profile of support structure 107 may be similar to the shape of shell 101. In the illustrated example, this shape is a circular ring. However, it should be appreciated that shell 101 and support structure 107 may be formed into any other desired shape. As a result of support structure 107 conforming to the shape of shell 101, the outer side surfaces of support structure 107 may guide the flow of the cooled, thermally conductive liquid down the side surfaces of shell 101. By doing so, the volume of thermally conductive liquid exterior the chassis 117 (volume 111A) remains in contact with shell 101 for a greater period of time, allowing more heat to be conductively transferred to shell 101. Since the downward flow of the liquid is concentrated on the outer surface of shell 101, the shear force between the upward flowing liquid at the center of LED bulb 100 and the downward flowing liquid along the surface of shell 101 is reduced, thereby increasing the convective flow of thermally conductive liquid within LED bulb 100.

Once reaching the bottom of shell 101, the thermally conductive liquid flows through opening 119, situated towards the bottom, and rises within chassis 117 as heat generated by LEDs 103 warms the liquid. The heated volume of thermally conductive liquid within chassis 117 (volume 111B) is again guided through the chassis as described above. The described convective cycle continuously repeats during operation of LED bulb 100 to cool LEDs 103. It should be appreciated that the convective flow described above represents the general flow of liquid within shell 101. One of ordinary skill in the art will recognize that some of the thermally conductive liquid may not reach the top and bottom of shell 101 before being cooled or heated sufficiently to cause the liquid to fall or rise. It should also be recognized that the convective flow created by chassis 117 can supplement the convective flow created by mounts 202 and channels 204 (FIG. 2).

FIG. 4C illustrates a cross-sectional view of the top portion of LED bulb 100 positioned in an upside-down vertical orientation in which shell 101 is disposed vertically below base 110. The arrows indicate the direction of liquid flow during operation of LED bulb 100. The volume of thermally conductive liquid within chassis 117 (volume 111B) heats faster than the surrounding liquid and rises through opening 119 to the top (previously bottom) of shell 101. This is due to the heat generated by LEDs 103 conductively transferred to thermally conductive liquid via LEDs 103. As the thermally conductive liquid is heated, its density decreases, thereby causing the heated liquid to rise to the top (previously bottom) of LED bulb 100.

Once the heated, thermally conductive liquid reaches the top (previously bottom) portion of shell 101, heat is conductively transferred to shell 101, causing a volume of thermally conductive liquid exterior the chassis 117 (volume 111A) to cool. As the thermally conductive liquid cools, its density increases, thereby causing the cooler liquid to fall. Since the heated, thermally conductive liquid is forced up and outwards in an upside-down vertical orientation, the cooled, thermally conductive liquid falls down the sides of shell 101. This allows the volume of thermally conductive liquid exterior the chassis 117 (volume 111A) to remain in contact with shell 101 for a greater period of time, allowing more heat to be conductively transferred to shell 101. In addition, since the downward flow of thermally conductive liquid is concentrated along the surface of shell 101, the shear force between the upward flowing liquid at the center of LED bulb 100 and the downward flowing liquid along the surface of shell 101 is reduced, thereby increasing the convective flow liquid within LED bulb 100.

Once reaching the bottom (previously top) of shell 101, the volume of thermally conductive liquid exterior the chassis 117 (volume 111A) may move through opening 118 and rise as heat generated by LEDs 103 warms the liquid. The described convective cycle continuously repeats during operation of LED bulb 100 to cool LEDs 103. It should be appreciated that the convective flow described above represents the general flow of liquid within shell 101. One of ordinary skill in the art will recognize that some of thermally conductive liquid may not reach the top and bottom of shell 101 before being cooled or heated sufficiently to cause the liquid to fall or rise. It should also be recognized that the convective flow created by chassis 117 can supplement the convective flow created by mounts 202 and channels 204 (FIG. 2).

### 2. Thermal Models

The following examples demonstrate heat distribution within a bulb around a chassis and how the addition of openings 118 and 119 facilitate an effective passive convection flow of the thermal conductive liquid that cools the LEDs. In each of the examples, body portion 117A and cap portion 117B are made of aluminum and form chassis 117. Shell 101 is made from transparent polycarbonate and encloses the silicone oil and the chassis. To account for thermal expansion of the silicone oil, a compressible bladder is added within the shell and chassis that expands and contracts accordingly. For simplicity, the temperature on the outside wall of shell 101 is maintained at 70 degrees Celsius and 6.2 Watts of heat is applied to the side of cap portion 117B.

The model extrudes in three dimensions using a field solver that discretizes mesh nodal points to resolve solutions for the heat equations for the polycarbonate shell, aluminum chassis, and the diaphragm, as well as the fluid flow heat transfer equations of the silicone oil. Further, each exemplar model orients the top portion of LED bulb 100 positioned upright and vertical in which shell 101 is disposed vertically above base 110.

A. Model with Opening 118

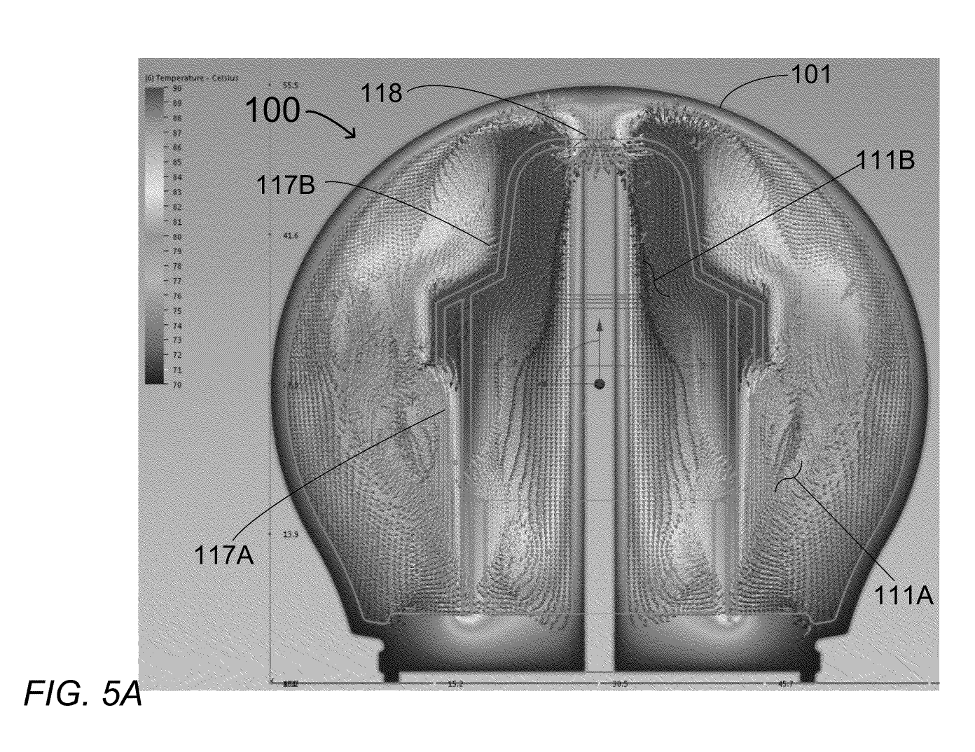

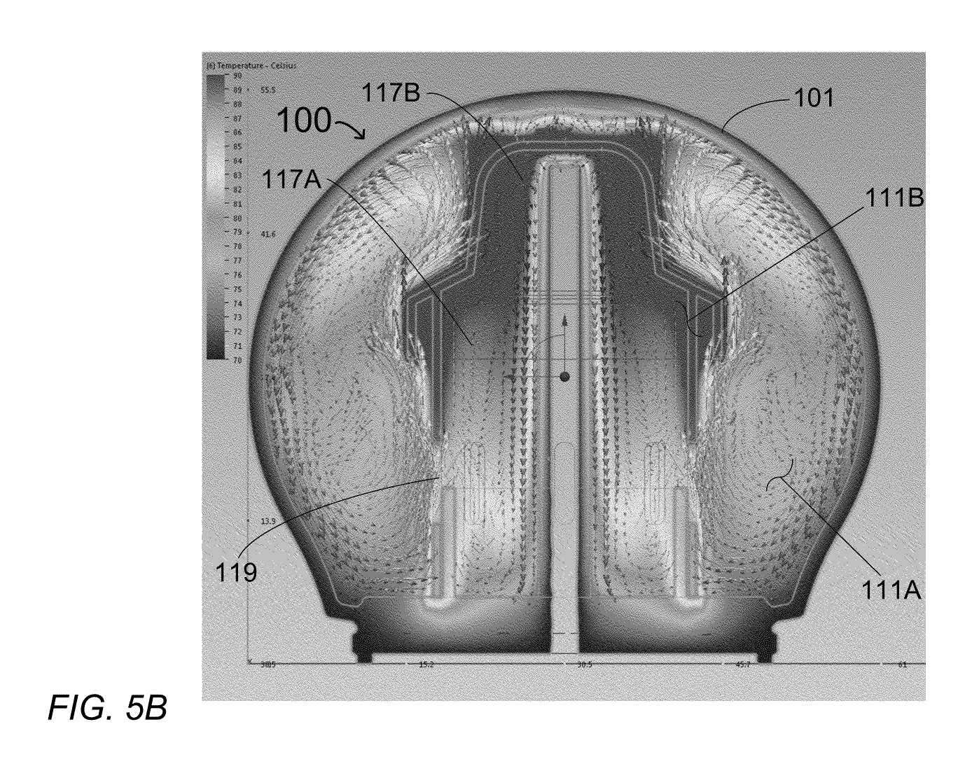

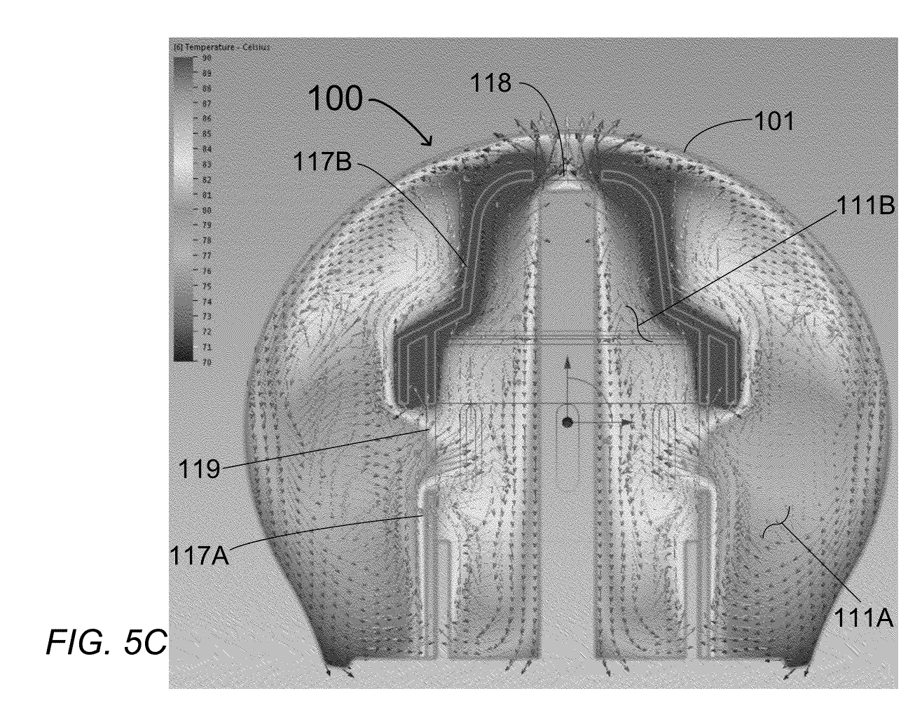

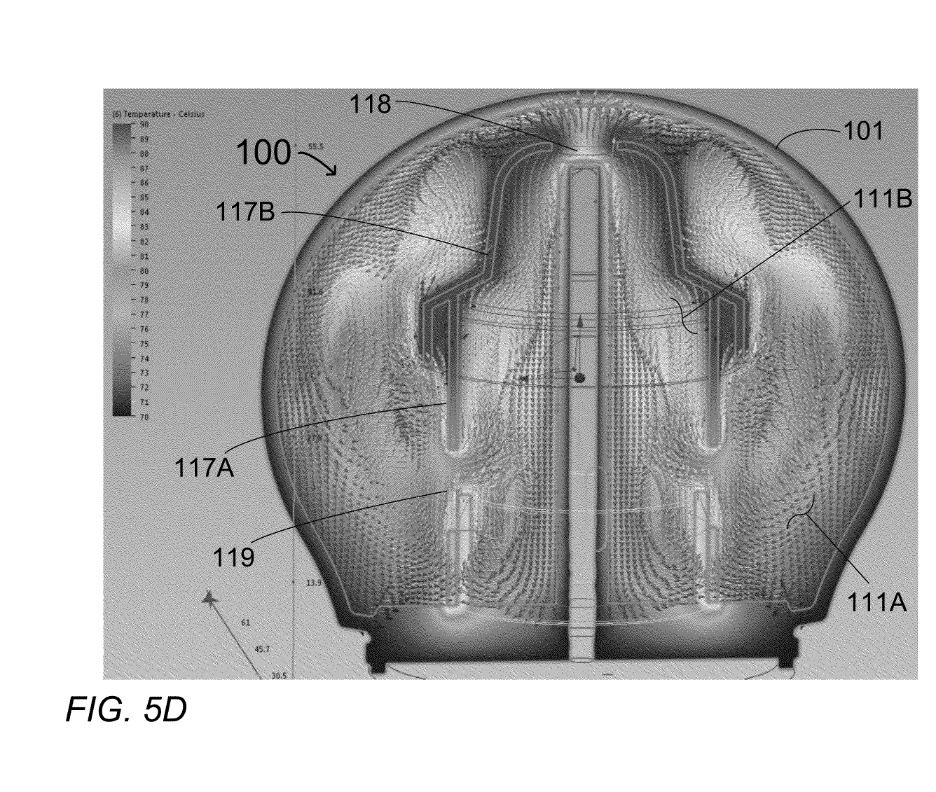

FIG. 5A illustrates a cross-sectional view of the thermal model of the steady state heat distribution for the bulb with a maximum temperature of 95.1 degrees Celsius. The model includes a 6.5 mm diameter opening 118 formed in the top of cap portion 117B. This configuration impedes the exchange between the cooler volume of silicone oil exterior the chassis 117 (volume 111A) and the warmer volume of silicone oil within the chassis 117 (volume 111B). The exchange is only permitted through opening 118. As such, the passive thermal convective flow of the silicone oil forms two separate cycles: one cycle within the chassis consisting predominately of heated silicon oil and another cycle outside the chassis consisting predominately of cooler silicone oil. For the most part these passive convective flow cycles function separately with limited convective flow exchange.

The inner chassis passive convective flow cycle has a large volume of heated silicon oil contained within cap portion 117B since the silicone oil is exposed to a large portion of the heated chassis with limited access to cooler silicone oil near the shell surface. As illustrated in FIG. 5A, the cooler silicon oil above opening 118 falls through the center of opening 118 and around the compressible bladder to base 110, while the heated silicone oil rises along chassis 117 and through opening 118 in close proximity to chassis 117. The heated silicone oil exiting chassis 117 rises to shell 101 and cools, where most falls back into chassis 117 and continues the cycle described above.

The outer chassis passive convective flow cycle has a large volume of colder silicon oil since the silicone oil is exposed to a large portion of the shell surface. Heated silicon oil exterior the chassis 117 (volume 111A) rises along the surface of cap portion 117B to the surface of shell 101 and remains in contact with shell 101 for a greater period of time, allowing more heat to be conductively transferred to shell 101. The silicone oil impinges on the outside surface of chassis 117, thereby providing significant cooling to the chassis as depicted in FIG. 5A. The silicone fluid warms, rises, and is directed in close proximity to the chassis toward shell 101 in which the silicone oil continually repeats the cycle described above.

It should be appreciated that the passive thermal convective flow cycles described above represent the general flow of liquid within shell 101. One of ordinary skill in the art will recognize that some of the silicone oil may not reach the top and bottom of shell 101 before being cooled or heated sufficiently to cause the silicon to fall or rise.

B. Model with Openings 119

FIG. 5B illustrates a cross-sectional view of the thermal model of the steady state heat distribution for the bulb with a maximum temperature of 94.9 degrees Celsius. The model includes opening 119 configured as a set of slots, each slot 2 mm wide and 6 mm high, spaced around the circumference of body portion 117A situated toward base 110.

This configuration impedes the exchange between the cooler volume of silicone oil exterior the chassis 117 (volume 111A) and the warmer volume of silicone oil within the chassis 117 (volume 111B). The exchange is limited to opening 119. Thus, as depicted in FIG. 5B, cap portion 117B encloses the heated silicon oil and maintains a fairly uniform temperature distribution of the heated volume of silicone oil within the chassis 117 (volume 111B), particularly, within cap portion 117B. As such, the thermal passive convective flow of the silicone oil forms two separate cycles: one cycle within chassis 117 consisting predominately of heated silicon oil and another cycle outside chassis 117 consisting predominately of cooler silicone oil. For the most part, these passive convective flow cycles function separately with limited exchange.

The inner chassis passive convective flow cycle is driven by the interaction of the large volume of silicone oil within cap portion 117B and the coolness of the compressible bladder in the center of chassis 117, which creates a thermal gradient sufficient to cool some of the heated silicon oil within cap portion 117B. The cooler compressible bladder diaphragm causes the silicone oil to fall preferentially along the cooler region that is in close proximity to the compressible bladder. The silicone oil then heats and rises along the warmer chassis 117 toward cap portion 117B. Upon warming, some of the silicone oil may exchange through opening 119 and rise in close proximity to the exterior of the chassis. However, as shown in FIG. 5B most of the warmed silicone oil is directed to remain on the inside of chassis 117. Thus, the volume of silicone oil within chassis 117 (volume 111B), for the most part, cycles only inside chassis 117.

The volume of silicone oil exterior the chassis 117 (volume 111A) exhibits a similar heating and cooling cycle where cap portion 117B heats the silicone oil and rises in close proximity to the surface of cap portion 117B. The silicone oil is brought into close proximity to the surface of shell 101, cools, and falls along the surface of shell 101. The falling silicone oil remains in contact with shell 101 for a large period of time, allowing more heat to be conductively transferred to shell 101. The colder silicone oil impinges on the outside surface of chassis 117, drastically cooling the chassis region below opening 119 as depicted in FIG. 5B. The silicone fluid again warms, rises, and continues the cycle described above.

C. Model with Openings 118 and 119

FIG. 5C illustrates a cross-sectional view of the thermal model of the steady state heat distribution for the bulb with a maximum temperature of 94.0 degrees Celsius. The model includes opening 119 configured as a set of slots, each slot 2 mm wide and 6mm high, spaced around the circumference of body portion 117A, positioned near cap portion 117B. The model further has a 6.5 mm diameter opening 118 in the top of cap portion 117B. This configuration facilitates a passive thermal convective flow cycle that promotes the exchange between the cooler volume of silicone oil exterior the chassis 117 (volume 111A) and the warmer volume of silicone oil within the chassis 117 (volume 111B).

As illustrated in FIG. 5C, the cap portion 117B warms the silicone oil within chassis 117. The heated silicone oil rises though opening 118 and is directed in close proximity to shell 101. The silicon oil cools and falls along the surface of shell 101 and remains in contact with shell 101 for a large period of time, allowing more heat to be conductively transferred to shell 101. The colder silicone oil is directed along the surface of shell 101, and impinges on the outside surface of body portion 117A, which cools the chassis region below opening 119 as depicted in FIG. 5C. The silicone fluid again warms, rises, and is preferentially directed up through opening 119 in close proximity of the warm chassis walls towards cap portion 117B. The described convective cycle continuously repeats. It should be appreciated that the convective flow described above represents the general flow of liquid within shell 101.

FIG. 5C has other minor cycles that mix with the main cycle described above. For example, heated silicone oil on the outside of cap portion 117B rises toward shell 101. The silicone oil then cools and falls along the inner surface of shell 101. The silicone oil may be directed to the region slightly above opening 119, exterior chassis 117, where the silicone oil warms and rises, being directed along the surface of the outside of cap portion 117B where the cycle begins again. It should be recognized that the silicone oil in this cycle intermixes the main cycle described above when the oil is in close proximity to shell 101, thereby providing greater exchange between the warmer and cooler regions of LED bulb 100.

Another minor passive thermal flow cycle example includes volume of silicone oil within the chassis 117 (volume 111B) that cools in proximity to the compressible bladder in the center of chassis 117. The cooler silicone oil falls and is directed in proximity to the compressible bladder towards base 110. The silicone oil then heats and rises along the warmer body portion 117A toward cap portion 117B and again cools in proximity to the compressible bladder where the cycle begins again. It should be recognized that the silicone oil in this minor cycle intermixes the main cycle described above when the oil is in close proximity to the chassis interior, thereby providing greater exchange between the cooler volume of silicone oil exterior the chassis 117 (volume 111A) and the warmer volume of silicone oil within the chassis 117 (volume 111B).

D. Model with Openings 118 and 119 Near Base

FIG. 5D illustrates a cross-sectional view of the thermal model of the steady state heat distribution for LED bulb 100 with a maximum temperature of 93.5 degrees Celsius. The model includes opening 119 configured as a set of slots, each slot 2 mm wide and 6 mm high, spaced around the circumference of body portion 117A positioned preferentially closer to base 110. The model further has a 6.5 mm diameter opening 118 in the top of cap portion 117B.

This configuration improves the model illustrated in FIG. 5C by increasing the exchange between the cooler volume of silicone oil exterior the chassis 117 (volume 111A) and the warmer volume of silicone oil within the chassis 117 (volume 111B). Specifically, lowering opening 119 provides access to the cooler silicone oil near base 110. The cooler silicon oil exchange convectively transfers heat from the bottom of chassis 117 as opposed to impinging on the outer surface and conductively transferring the heat. Thus, lowering opening 119 as depicted in FIG. 5D further optimizes the thermal exchange and decreases the maximum modeled temperature by 0.5 degrees Celsius compared to FIG. 5C.

Although the invention has been described in conjunction with particular embodiments, it should be appreciated that various modifications and alterations may be made by those skilled in the art without departing from the spirit and scope of the invention. Embodiments may be combined and aspects described in connection with an embodiment may stand alone.

What is claimed is:

1. A light emitting diode (LED) bulb comprising:
a base;
a shell connected to the base forming an enclosed volume;
a thermally conductive liquid disposed within the enclosed volume;
a plurality of LEDs disposed within the shell and immersed in the thermally conductive liquid; and
a chassis disposed within the shell and immersed in the thermally conductive liquid, wherein the chassis has a first opening and a second opening, wherein the second opening is spaced from the first opening to facilitate a passive convective flow of the thermally conductive liquid to exchange a first volume of the thermally conductive liquid interior the chassis with a second volume of the thermally conductive liquid exterior the chassis.

2. The LED bulb of claim 1, wherein the chassis comprises:
a body portion; and
a cap portion.

3. The LED bulb of claim 2, wherein the first opening is formed in the cap portion, and wherein the second opening is formed in the body portion.

4. The LED bulb of claim 3, wherein the first opening is located proximate a first end of the enclosed volume, wherein the second opening is located proximate a second end of the enclosed volume, and wherein the second end is opposite the first end.

5. The LED bulb of claim 3, wherein the second opening is configured as a set of slots spaced around the body portion.

6. The LED bulb of claim 2, wherein the body portion is tubular shaped, and wherein the cap portion is dome shaped.

7. The LED bulb of claim 1, wherein the chassis is configured to facilitate the passive convective flow when the LED bulb is oriented in at least three different orientations comprising:
a first orientation in which the shell is disposed vertically above the base;
a second in which the shell is disposed on the same horizontal plane as the base; and
a third orientation in which the shell is disposed vertically below the base.

8. The LED bulb of claim 1, further comprising:
a support structure, wherein the LEDs are mounted to the support structure.

9. The LED bulb of claim 8, wherein the support structure comprises:
a plurality of tabs, wherein one of the LEDs is mounted to one of the tabs, and wherein a channel is formed between pairs of tabs.

10. The LED bulb of claim 8, wherein the support structure is secured around the chassis.

11. The LED bulb of claim 10, wherein the support structure includes openings, wherein the chassis includes tabs, and wherein the openings of the support structure engage with the tabs of the chassis.

12. The LED bulb of claim 1, further comprising:
a volume compensation mechanism.

13. The LED bulb of claim 12, wherein the volume compensation mechanism is a compressible bladder or a diaphragm.

14. The LED bulb of claim 1, wherein the thermally conductive liquid is silicone oil.

15. A light emitting diode (LED) bulb comprising:
a base;
a shell connected to the base forming an enclosed volume;
a thermally conductive liquid disposed within the enclosed volume;
a plurality of LEDs disposed within the shell and immersed in the thermally conductive liquid; and
a chassis disposed within the shell and immersed in the thermally conductive liquid, wherein the chassis has a first opening and a second opening, wherein the first opening is proximate a first end of the enclosed volume and the second opening is proximate a second end of the enclosed volume to facilitate a passive convective flow of the thermally conductive liquid to exchange a first volume of the thermally conductive liquid interior the chassis with a second volume of the thermally conductive liquid exterior the chassis.

16. The LED bulb of claim 15, wherein the chassis comprises:
a body portion; and
a cap portion.

17. The LED bulb of claim 16, wherein the first opening is formed in the cap portion, and wherein the second opening is formed in the body portion.

18. The LED bulb of claim 17, wherein the second opening is configured as a set of slots spaced around the body portion.

19. The LED bulb of claim 16, wherein the body portion is tubular shaped, and wherein the cap portion is dome shaped.

20. The LED bulb of claim 15, wherein the chassis is configured to facilitate the passive convective flow when the LED bulb is oriented in at least three different orientations comprising:
a first orientation in which the shell is disposed vertically above the base;
a second in which the shell is disposed on the same horizontal plane as the base; and
a third orientation in which the shell is disposed vertically below the base.

21. The LED bulb of claim 15, further comprising:
a support structure, wherein the LEDs are mounted to the support structure.

22. The LED bulb of claim 21, wherein the support structure comprises:
a plurality of tabs, wherein one of the LEDs is mounted to one of the tabs, and wherein a channel is formed between pairs of tabs.

23. The LED bulb of claim 21, wherein the support structure is secured around the chassis.

24. The LED bulb of claim 23, wherein the support structure includes openings, wherein the chassis includes tabs, and wherein the openings of the support structure engage with the tabs of the chassis.

25. The LED bulb of claim 15, further comprising:
a volume compensation mechanism.

26. The LED bulb of claim 25, wherein the volume compensation mechanism is a compressible bladder or a diaphragm.

27. A method of making a light emitting diode (LED) bulb, comprising:
obtaining a base;
connecting a shell to the base to form an enclosed volume, wherein the enclosed volume is filled with a thermally conductive liquid;
disposing a plurality of LEDs within the shell; and
disposing a chassis within the shell, the chassis having a first opening and a second opening, wherein the second opening is spaced from the first opening to facilitate a passive convective flow of the thermally conductive liquid to exchange a first volume of the thermally conductive liquid interior the chassis with a second volume of the thermally conductive liquid exterior the chassis.
